(19) United States
(12) Patent Application Publication
(10) Pub. No.: US 2020/0110627 A1
(43) Pub. Date: Apr. 9, 2020

(54) CENTRALIZED UNIT AND DISTRIBUTED UNIT CONNECTION IN A VIRTUALIZED RADIO ACCESS NETWORK

(71) Applicant: Intel IP Corporation, Santa Clara, CA (US)

(72) Inventors: Joey Chou, Scottsdale, AZ (US); Yizhi Yao, Chandler, AZ (US)

(21) Appl. No.: 16/499,861

(22) PCT Filed: Apr. 24, 2018
(86) PCT No.: PCT/US2018/029200

§ 371 Date: Sep. 30, 2019

Related U.S. Application Data
(60) Provisional application No. 62/489,741, filed on Apr. 25, 2017.

(51) Int. Cl. G06F 9/455; H04L 12/24

(52) U.S. Cl. CPC G06F 9/45558; H04L 41/0896; G06F 2009/45595; H04L 41/12; H04L 41/0806; H04L 41/0893

(57) ABSTRACT

This disclosure describes systems, methods, and devices related to centralized unit (CU) and distributed unit (DU) connection in virtualized access network (RAN) system. An device may determine a network service (NS) instance associated with a network service descriptor (NSD). The device may determine latency attributes and bandwidth attributes associated with one or more virtual links associated with an interface between a first component of the device and a second component of the device. The device may cause to send an onboarding request to a network function virtualization orchestrator (NFVO), wherein the onboarding request comprises the latency attributes and the bandwidth attributes. The device may determine an onboarding response received from the NFVO.

### CROSS-REFERENCE TO RELATED APPLICATIONS

This application claims the benefit of U.S. Provisional Application 62/489,741, filed Apr. 25, 2017, the disclosure of which is incorporated herein by reference as if set forth in full.

### TECHNICAL FIELD

This disclosure generally relates to systems, methods, and devices for wireless communications and, more particularly, centralized unit (CU) and distributed unit (DU) connection in a virtualized radio access network (RAN).

### BACKGROUND

Wireless mobile communication technology uses various standards and protocols to transmit data between a base station and a wireless mobile device. Wireless communication system standards and protocols can include the 3rd Generation Partnership Project (3GPP) long-term evolution (LTE); the Institute of Electrical and Electronics Engineers (IEEE) 802.16 standard, which is commonly known to industry groups as worldwide interoperability for microwave access (WiMAX); and the IEEE 802.11 standard for wireless local area networks (WLANs), which is commonly known to industry groups as Wi-Fi. In 3GPP radio access networks (RANs) in LTE systems, the base station can include a RAN node, such as an Evolved Universal Terrestrial Radio Access Network (E-UTRAN) Node B (also commonly denoted as evolved Node B, enhanced Node B, eNodeB, or eNB), and/or a Radio Network Controller (RNC) in an E-UTRAN, which communicate with a wireless communication device, known as user equipment (UE). In fifth generation (5G) wireless RANs, RAN nodes can include a 5G Node (e.g., 5G eNB or gNB).

### BRIEF DESCRIPTION OF THE DRAWINGS

FIGS. 1 and 2 depict illustrative schematic message flows for onboarding a network service descriptor (NSD), in accordance with one or more example embodiments of the present disclosure.

FIG. 3 depicts an illustrative schematic message flow for onboarding an NSD, in accordance with one or more example embodiments of the present disclosure.

FIG. 4A illustrates a flow diagram of an illustrative process for an illustrative centralized unit (CU) and distributed unit (DU) connection in a virtualized radio access network (RAN) system, in accordance with one or more example embodiments of the present disclosure.

FIG. 4B illustrates a flow diagram of an illustrative process for a CU and DU connection in a virtualized RAN system, in accordance with one or more example embodiments of the present disclosure.

FIG. 5 illustrates an architecture of a system of a network, in accordance with one or more example embodiments of the present disclosure.

FIG. 6 illustrates example components of a device, in accordance with one or more example embodiments of the present disclosure.

FIG. 7 illustrates example interfaces of baseband circuitry, in accordance with one or more example embodiments of the present disclosure.

FIG. 8 is an illustration of a control plane protocol stack, in accordance with one or more example embodiments of the present disclosure.

FIG. 9 is an illustration of a user plane protocol stack, in accordance with one or more example embodiments of the present disclosure.

FIG. 10 illustrates components of a core network, in accordance with one or more example embodiments of the present disclosure.

FIG. 11 is a block diagram illustrating components of a system to support network function virtualization (NFV), in accordance with one or more example embodiments of the present disclosure.

FIG. 12 is a block diagram illustrating one or more components, in accordance with one or more example embodiments of the present disclosure.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

A gNB is a 3GPP 5G Next Generation base station, which supports the 5G New Radio. The new radio access technology for 5G is called “NR” and replaces “LTE,”, and the new base station is called gNB (or gNodeB), and replaces the eNB (or eNodeB or Evolved Node B). A network manager (NM) provides a package of end-user functions with the responsibility for the management of a network, mainly as supported by one or more element managers (EMs), but it may also involve direct access to the network elements. An element manager (EM) provides a package of end-user functions for management of a set of closely related types of network elements.

A network service descriptor (NSD) is a deployment template, which consists of information used by the NFV Orchestrator (NFVO) for life cycle management of a network service (NS). That is, the NSD information element is a template, containing information associated with the characteristics of a Network Service (NS) that the NFVO can use to instantiate an NS via the lifecycle management operation. An NS is a composition of network functions (NFs) arranged as a set of functions with unspecified connectivity between them or according to one or more forwarding graphs. The NM may onboard an NSD that can be used to deploy an NS that includes the both the virtualized part and the non-virtualized part of the gNB.

The gNB may be split into a centralized unit (CU) (upper layer of new radio (NR) base station (BS)) and a distributed unit (DU) (lower layer NR BS).

A requirement may be that the NR should allow CU deployment with network function virtualization (NFV). Therefore, a gNB may comprise a CU that is implemented as virtualized network functions (VNFs) running in the cloud (e.g., on a server), and a DU running in the cell site that provides wireless communication to the UE.

Onboarding is a function that enables operators and service providers to import feature packages to components, where the packages comprise artifacts needed to bring up an instance of a virtual resource in a virtual resource environment. However, the onboarding function does not support network parameters (e.g., bandwidth parameters) defined in the transport network requirements since one or more information elements that facilitate the onboarding (e.g., quality of service (QoS) information element) do not contain any bandwidth attribute.

Embodiments herein relate to a method to provide the transport network requirements (e.g., bandwidth and latency) of the CU-DU interface to ETSI network function virtualization (NFV) manageability and orchestration (MANO). ETSI NFV MANO may use such information to create a connection for the CU and DU in order to form a gNB.

In one or more embodiments, a New Radio (NR) RAN node or gNB may include a CU (e.g., upper layer of new radio base station (BS)) that may be implemented as virtualized network functions (VNFs) deployed in the cloud, and a DU (e.g., lower layer of new radio BS) that may be implemented as physical network functions (PNFs) deployed in the cell site to provide wireless communication to user equipment (UE).

In one or more embodiments, a CU and DU connection in a virtualized RAN system may define an interface between the CU and DU that may meet specific transport network requirements that are characterized by latency and bandwidth.

In one or more embodiments, a CU and DU connection in a virtualized RAN system may include a network manager (NM) comprising one or more processors. The NM may send a request to a network function virtualization orchestrator (NFVO) to onboard the NS descriptor (NSD). The NM may receive from the NFVO the result of the NSD onboard. The NM may send a request to the NFVO to update the NSD. The NM may receive from the NFVO the result of the NSD update. The result may be a success of the NSD onboarding or a failure of NSD onboarding. In case of a failure, then the NSD may not have been onboarded.

In one or more embodiments, a CU and DU connection in a virtualized RAN system may facilitate that the NM requests the NFVO to onboard the NSD with a virtual link descriptor that contains the latency and bandwidth attributes needed for the creation of virtual links to connect the CU and DU.

In one or more embodiments, a CU and DU connection in a virtualized RAN system may facilitate that the NM requests the NFVO to update the NSD by adding a VNF forwarding graph descriptor (VNFFGD), which includes the virtual link descriptor that contains the latency and bandwidth attributes needed for the creation of virtual links to connect the CU and DU.

In one or more embodiments, a CU and DU connection in a virtualized RAN system may facilitate that the NM requests the NFVO to update the virtual link descriptor containing the latency and bandwidth attributes needed for the creation of virtual links to connect the CU and DU.

In one or more embodiments, a CU and DU connection in a virtualized RAN system may facilitate that once an NSD is onboarded, the NM comprising one or more processors may send a request to the NFVO to create a new NS identifier; may receive from the NFVO the new NS identifier; may send a request to the NFVO to instantiate an NS that includes the instantiation of a new VNF to implement the CU, and deploy a PNF to implement the DU; may receive from the NFVO the operation result containing the lifecycle operation occurrence identifier; may receive from the NFVO the NS lifecycle change notification to the NM indicating the start of NS instantiation; may send a request to the NFVO to update an NS that includes the virtualized part and non-virtualized part of the gNB; may receive from the NFVO the operation result containing the lifecycle operation occurrence identifier; may receive from the NFVO the NS lifecycle change notification to the NM indicating the start of an NS update; and/or may receive from the NFVO the NS lifecycle change notification to the NM indicating the result of the NS update.

In one or more embodiments, a CU and DU connection in a virtualized RAN system may facilitate that the NM requests the NFVO to use the NS update to add a VNF forwarding graph (VNFFG) to an NS with the VNFFG descriptor, which includes the virtual link descriptor containing the latency and bandwidth attributes needed for the creation of virtual links to connect the CU and DU.

In one or more embodiments, a CU and DU connection in a virtualized RAN system may facilitate that the NFVO perform the NSD onboard in response to the NSD onboard request; may send the result of the NSD onboard to the NM; may perform the NSD update in response to the NSD update request; and/or may send the result of the NSD update to the NM.

In one or more embodiments, a CU and DU connection in a virtualized RAN system may facilitate that the NFVO send the NS identifier to the NM; may send the operation result containing the lifecycle operation occurrence identifier to the NM; may send the NS lifecycle change notification to the NM indicating the start of NS instantiation to the NM; and/or may send the NS lifecycle change notification to the NM indicating the result of NS instantiation to the NM.

The above descriptions are for purposes of illustration and are not meant to be limiting. Numerous other examples, configurations, processes, etc., may exist, some of which are described in detail below. Example embodiments will now be described with reference to the accompanying figures.

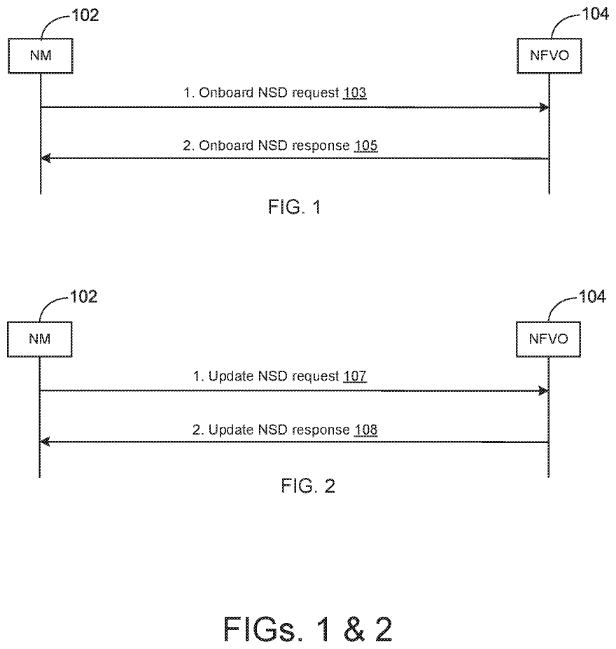

FIGS. 1 and 2 depict illustrative schematic message flows for onboarding the network service descriptor (NSD), in accordance with one or more example embodiments of the present disclosure.

Referring to FIG. 1A, there is shown a network manager (NM) 102 and a network function virtualization orchestrator (NFVO) 104, which are in communication in order to perform NSD onboard operations. The NSD contains information elements (IEs), such as a physical network function descriptor (PNFD), a virtual network function descriptor (VNFD), virtual link descriptors (VLDs), and/or virtualized network function (VNF) forwarding graph descriptors (VNFFGDs). The NM 102 may send an onboard NSD request 103 to the NFVO 104 to onboard the NSD information elements that are used as the deployment template for the NFVO 104 to perform the lifecycle management of network services (NSs).

In one or more embodiments, the NM 102 may request the NFVO 104 to onboard the NSD including the virtual link descriptor and the virtual link profile that contain the latency and bandwidth attributes. The virtual link descriptor, a virtual link profile, and a VirtualLinkToLevelMapping information element (for the virtual links (VLs)) in an NS level may be used for the creation of VLs to connect the virtualized part and the non-virtualized part of the gNB. After the NFVO 104 onboards the NSD, the NFVO 104 may respond to the NM 102 by sending an onboard NSD response 105 to indicate the successful NSD onboarding.

Referring to FIG. 2, there is shown messaging between the NM 102 and the NFVO 104 that may be used to update the NSD. For example, once the NSD is onboarded (as shown in FIG. 1), the NM 102 may send an update NSD request 107 to the NFVO 104 to add or remove the constituent information elements. The NFVO 104 may respond with an update NSD response 108 indicating that onboarding has been updated.

A requirement may be that the NR should allow CU deployment with network function virtualization (NFV). Therefore, a gNB may comprise a CU that is implemented as VNFs running in the cloud, and a DU running in the cell site that provides wireless communication to the UE.

However, the onboarding function does not support bandwidth parameters defined in the transport network requirements since one or more information elements that facilitate the onboarding (e.g., quality of service (QoS) information element) may not contain any bandwidth attributes.

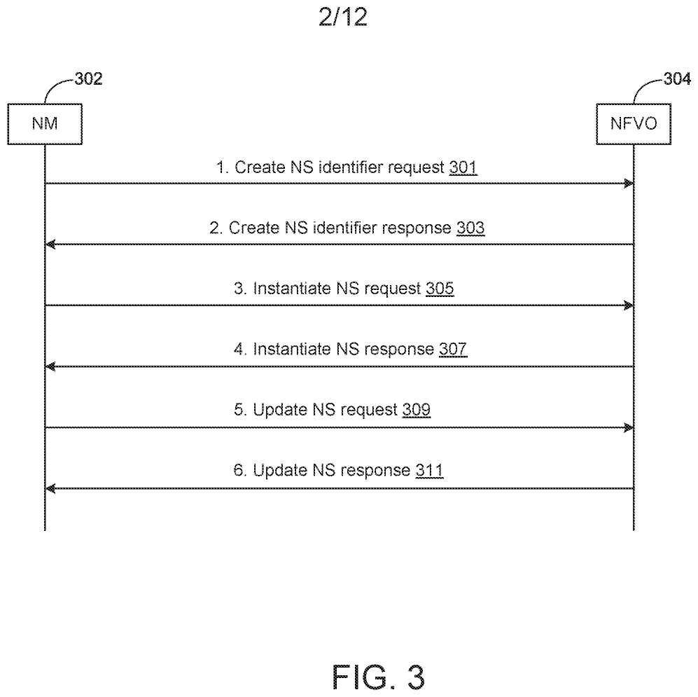

FIG. 3 depicts an illustrative schematic message flow for onboarding NSD, in accordance with one or more example embodiments of the present disclosure.

Referring to FIG. 3, there is shown an NM 302 and an NFVO 304, which are in communication in order to perform NSD onboard operations. The NSD contains information elements (IEs), such as a physical network function descriptor (PNFD), a virtual network function descriptor (VNFD), virtual link descriptors (VLDs), and/or VNF forwarding graph descriptors (VNFFGDs).

In one or more embodiments, a CU and DU connection in a virtualized RAN system may support a RAN functional split into CU and DU and may define transport characteristics such as transport latency and transport bandwidth, which are relevant for the functional split into CU and DU.

A 3GPP specification (e.g., 3GPP TR 38.801: “Study on New Radio Access Technology; Radio Access Architecture and Interfaces”) specifies the requirements on the underlying transport network for each functional split.

In one embodiment, the NM 302 may send onboard NSD request (e.g., onboard NSD request 103 of FIG. 1). For example, when the NM sends an onboarding request to the NFVO, the request may comprise one or more IEs. The one or more IEs may include an NSD IE. The NSD IE may include a virtualLinkDesc IE. The virtualLinkDesc IE may include one or more IEs, such as a VirtualLinkDf IE. The VirtualLinkDf IE contains the QOS attribute.

In one or more embodiments, the NSD IE may be shown in Table 1.

TABLE 1
Attributes of the NSD Information Element:

| Attribute | Qualifier | Cardinality | Content | Description |
|---|---|---|---|---|
| nsdIdentifier | M | 1 | Identifier | Identifier of |
| | | | | this NSD |
| | | | | information |
| | | | | element. |
| | | | | It globally |
| | | | | uniquely |
| | | | | identifies |
| | | | | an instance of |
| | | | | the NSD. |
| . | . | . | . | . |
| . | . | . | . | . |
| . | . | . | . | . |
| virtualLinkDesc | M | 0 . . . N | NsVirtual | Provides the |
| | | | LinkDesc | constituent |
| | | | VLDs. | |

As shown in Table 1, an NSD IE may include a NSD identifier. The NSD identifier may identify the NSD IE and which may globally identify an instance of the NSD. Further, the NSD IE may contain a virtualLinkDesc attribute. The virtualLinkDesc attribute may also be an IE that may be comprised of one or more attributes.

In one or more embodiments, the NsVirtualLinkDesc IE may be shown in Table 2.

TABLE 2
Attributes of the NsVirtualLinkDesc Information Element:

| Attribute | Qualifier | Cardinality | Content | Description |
|---|---|---|---|---|
| virtualLinkDescId | M | 1 | Identifier | Identifier of the |
| | | | | NsVirtualLinkDesc |
| | | | | information element. It |
| | | | | uniquely identifies a VLD. |
| . | . | . | . | . |
| . | . | . | . | . |
| . | . | . | . | . |
| virtualLinkDf | M | 1 . . . N | VirtualLink | See clause 6.5.4. |
| | | | Df | |

As shown in Table 2, the virtualLinkDesc IE contains a virtualLinkDf attribute. The virtualLinkDf attribute may be an IE that may be comprised of one or more attributes, as shown in Table 3.

TABLE 3
Attributes of the VirtualLinkDf information element:

| Attribute | Qualifier | Cardinality | Content | Description |
|---|---|---|---|---|
| flavourId | M | 1 | Identifier | Identifies this |
| | | | | VirtualLinkDf |
| | | | | information element |
| | | | | within a VLD. |
| QoS | M | 0 . . . 1 | QoS | See clause 6.5.6 |

As shown in Table 3, the virtualLinkDf IE contains a QoS attribute. The QoS attribute may be an IE that may be comprised of one or more attributes, as shown in Table 4.

TABLE 4
Attributes of the QoS Information Element:

| Attribute | Cardinality | Cardinality | Content | Description |
|---|---|---|---|---|
| latency | M | 1 | Number | Specifies the maximum |
| | | | | latency in ms. |
| packetDelayVariation | M | 1 | Number | Specifies the maximum |
| | | | | jitter in ms. |
| packetLossRatio | M | 0 . . . 1 | Number | Specifies the maximum |
| | | | | packet loss ratio. |
| priority | M | 0 . . . 1 | Integer | Specifies the priority |
| | | | | level in case of |
| | | | | congestion on the |
| | | | | underlying physical |
| | | | | links. |

An embodiment of the NSD onboarding procedure does not support bandwidth parameters defined in the transport network requirements (e.g., in 3GPP TR 38.801), since the information element QoS does not contain the bandwidth attribute.

In an illustrative use case of onboarding an NSD for the gNB, the onboarding NSD may include a virtual link descriptor to be used for the creation of VLs for connecting the virtualized part and the non-virtualized part of the gNB. For example, a network operator may need to be able to onboard an NSD that can be used to deploy an NS that includes both the virtualized part and the non-virtualized part of the gNB. However, the NSD onboarding use case does not include the VL descriptor that supports the bandwidth parameter.

In one or more embodiments, a CU and DU connection in a virtualized RAN system may include the virtual link descriptor latency and bandwidth parameters. One or more pre-conditions for the NSD onboarding procedure may include: (1) a VNF package for the virtualized part of a gNB has been onboarded; (2) the VNF packages for other constituent VNFs, if any, have been onboarded; and/or (3) the physical network function descriptors (PNFDs) for the constituent physical network functions (PNFs), if any, have been onboarded.

In one or more embodiments, in the NSD onboarding procedure, the NM (e.g., NM 302) requests the NFVO (e.g., NFVO 304) to onboard the NSD with a virtual link descriptor. The virtual link descriptor may contain latency and bandwidth attributes. The virtual link descriptor is needed for the creation of VLs to connect the virtualized part and the non-virtualized part of the gNB. After that, the NFVO (e.g., NFVO 304) onboards the NSD. Then the NFVO (e.g., NFVO 304) responds to the NM (e.g., NM 302) to indicate the successful NSD onboarding. A post-condition for the NSD onboarding procedure may be that the NSD containing the virtual link descriptor for the gNB has been onboarded.

In one or more embodiments, in the use case of adding a VNFFGD to an NSD containing VLs for virtualized and non-virtualized parts of the gNB, a CU and DU connection in a virtualized RAN system may use an “add” operation in the NSD update to add VNF forwarding graph descriptor (VNFFGD) to an NSD to include the transport bandwidth parameters. An NSD should contain the VNFFGD to enable the NS update operation to add a VNFFG to an NS. However, the VNFFGD may not contain the bandwidth attribute. Therefore, the existing NSD update operation of adding a VNFFGD to an NSD may not be able to connect the virtualized part and the non-virtualized part of a gNB.

In one or more embodiments, a CU and DU connection in a virtualized RAN system may facilitate that the VNFFGD may contain the bandwidth and latency attribute(s) in order for the NSD update operation of adding a VNFFGD to an NSD to connect the virtualized part and the non-virtualized part of a gNB. A pre-condition may be that the VNFFGD is missing in the NSD, since it was not included in the NSD onboarded, or has been removed.

In one or more embodiments, the NM (e.g., NM 302) may request that the NFVO (e.g., NFVO 304) use the NSD update to add a VNFFGD to an NSD, which includes the VL descriptor that may contain the latency and bandwidth attributes. The VL descriptor may be needed for the creation of VLs to connect the virtualized part and the non-virtualized part of the gNB. In this use case, the NFVO may add the VNFFGD to the NSD. The NFVO (e.g., NFVO 304) may respond to the NM (e.g., NM 302) to indicate that the VNFFGD has been added successfully. A post-condition for this use case may be that the VNFFGD, containing the VLs to connect the VNF instance that is part of the gNB and other VNF/PNF instances, has been added to the NSD.

An illustrative use case of updating the VLD for the VL between the virtualized part and the non-virtualized part of the gNB may use the NSD update operation (as in FIG. 2) to update the VLD of the NSD to include the transport bandwidth parameter. One or more issues may be that the operator may need to update the VLD (as part of the NSD) containing the transport network requirements between the virtualized part and the non-virtualized part of the gNB, before or after the virtualized part of the gNB is instantiated. A precondition may be that the NM knows the new attribute value for updating the VLD information elements indicating the transport network requirements between the virtualized part and the non-virtualized part of the gNB.

In one or more embodiments, a CU and DU connection in a virtualized RAN system may facilitate that the NM (e.g., NM 302) may request the NFVO (e.g., NFVO 304) to update the VLD containing the transport network requirements (e.g., transport latency, transport bandwidth) between the virtualized part and the non-virtualized part of the gNB. The attribute value of the VLD information elements to be updated are included in the request. In this case, the NFVO updates the VLD. Then the NFVO may respond to the NM that the VLD has been updated. A post-condition for updating the VLD for the VL between the virtualized part and the non-virtualized part of the gNB may be that the VLD containing the transport network requirements between the virtualized part and the non-virtualized part of the gNB has been updated.

Referring to FIG. 3, there is shown the network service (NS) lifecycle management operations which may include: (1) NS identifier creation—the NS identifier to point to the NSD; (2) NS instantiation—instantiate an NS based on the NSD pointed by the NS identifier; and (3) NS update—update the NS that was instantiated. For example, the NM 302 may send a create NS identifier request 301 to the NFVO 304. The NFVO 304 may respond by sending a create NS identifier response 303 to the NM 302. The NM 302 may send an instantiate NS request 305 to the NFVO 304. Then the NFVO 304 may send an instantiate NS response 307 to the NM 302. In case an update is needed, the NM 302 may send an update NS request 309 to the NFVO 304. The NFVO 304 may then respond with an update NS response 311 to the NM 302. It is understood that the above descriptions are for purposes of illustration and are not meant to be limiting.

In the illustrative use case of adding the VNFFGs to an NS containing VLs for the virtualized and the non-virtualized parts of the gNB, a CU and DU connection in a virtualized RAN system may facilitate adding a bandwidth attribute.

An NS instance may contain the VNFFGs including the VLs to connect the VNF instance that is part of the gNB with other VNF/PNF instances in the NS instance. However, the VNFFG may not contain the bandwidth attribute required by the transport network requirements. Therefore, the existing NS update operation of adding a VNFFG to an NS may not be able to connect the virtualized part and the non-virtualized part of a gNB. One or more pre-conditions for the use case may be that the NS instance containing the VNF instance that is part of the gNB already exists for the VNFFGs that were not provided during the NS instantiation, or have been removed from the NS instance.

In one or more embodiments, in the use case of adding the VNFFGs to an NS containing the VLs for the virtualized and the non-virtualized parts of a gNB, the NM (e.g., NM 302) requests the NFVO (e.g., NFVO 304) to use an NS update (as in FIG. 2) to add a VNFFG to a VNFFG descriptor, which may include the virtual link descriptor that contains the latency and bandwidth attributes, as defined in the transport network requirements. The virtual link descriptor may be needed for the creation of VLs to connect the virtualized part and the non-virtualized part of the gNB. In this case, the NFVO adds the VNFFGs to the NS. The NFVO may respond to the NM to indicate that the VNFFGs have been added successfully. A post-condition may be that the VNFFGs, containing the VLs to connect the VNF instance that is part of the gNB and other VNF/PNF instances, have been added to the NS instance. It is understood that the above descriptions are for purposes of illustration and are not meant to be limiting.

In one or more embodiments, a CU and DU connection in a virtualized RAN system may provide one or more requirements that may be implemented. The one or more requirements may include REQ-VRAN_Mgmt_LCM-CON-a, REQ-VRAN_Mgmt_LCM-CON-Y, REQ-VRAN_Mgmt_LCM-CON-x, and REQ-VRAN_Mgmt_LCM-CON-Y. The REQ-VRAN_Mgmt_LCM-CON-a indicates that the 3GPP management system may be able to onboard the NSD that includes a virtual link descriptor containing both latency and bandwidth information. The REQ-VRAN_Mgmt_LCM-CON-Y indicates that the 3GPP management system may be able to add the VNFFGs to an NS with the VNFFG descriptor that includes a virtual link descriptor containing both latency and bandwidth information elements. The REQ-VRAN_Mgmt_LCM-CON-x indicates that the 3GPP management system may be able to request the NFVO to update the VLD containing the transport network requirements between the virtualized part and the non-virtualized part of the gNB. The REQ-VRAN_Mgmt_LCM-CON-Y may also indicate that the 3GPP management system may be able to add the VNFFGD to an NSD that includes a virtual link descriptor containing both latency and bandwidth information. It is understood that the above descriptions are for purposes of illustration and are not meant to be limiting.

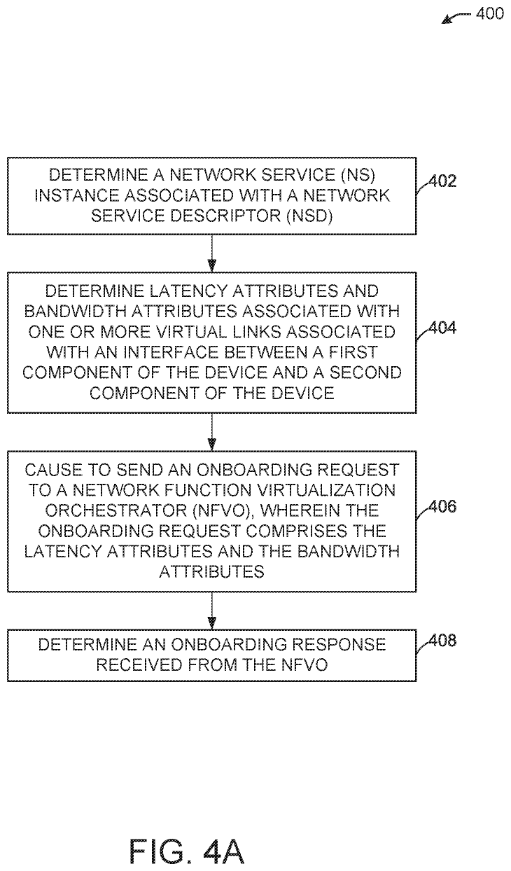

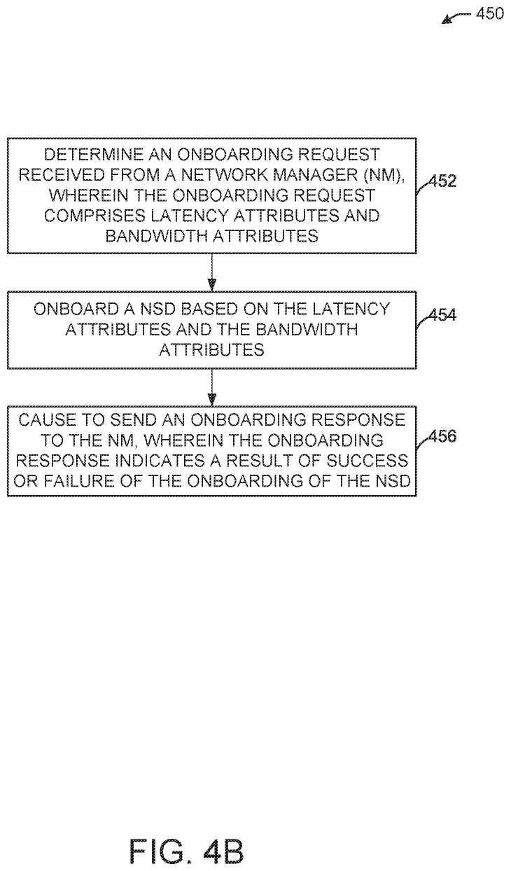

FIG. 4A illustrates a flow diagram of an illustrative process 400 for an illustrative CU and DU connection in a virtualized RAN system, in accordance with one or more example embodiments of the present disclosure.

At block 402, a device may determine a network service (NS) instance associated with a network service descriptor (NSD). The device may be a Next Generation Radio Access Network (gNB). The device may be split into a centralized unit (CU) (upper layer of new radio (NR) base station (BS)) and a distributed unit (DU) (lower layer NR BS). The network service descriptor (NSD) is a deployment template, which consists of information used by the NFV orchestrator (NFVO) for lifecycle management of a network service (NS). That is, the NSD information element is a template, containing information associated with the characteristics of a Network Service (NS) that the NFVO can use to instantiate an NS via the lifecycle management operation. An NS is a composition of network functions (NFs) arranged as a set of functions with unspecified connectivity between them or according to one or more forwarding graphs. The gNB may contain an NM that provides a package of end-user functions with the responsibility for the management of a network.

At block 404, the device may determine latency attributes and bandwidth attributes associated with one or more virtual links associated with an interface between a first component of the device and a second component of the device. For example, the device may provide the transport network requirements (e.g., bandwidth and latency) of the CU-DU interface to ETSI network function virtualization (NFV) manageability and orchestration (MANO). ETSI NFV MANO may use such information to create a connection for the CU and DU in order to form a gNB.

At block 406, the device may cause to send an onboarding request to a network function virtualization orchestrator (NFVO), wherein the onboarding request comprises the latency attributes and the bandwidth attributes. For example, an NM may request the NFVO to onboard the NSD including the virtual link descriptor and the virtual link profile that contain the latency and bandwidth attributes. The virtual link descriptor, the virtual link profile, and a VirtualLinkToLevelMapping information element (for the virtual links (VLs)) in an NS level are needed for the creation of VLs to connect the virtualized part and the non-virtualized part of the gNB.

At block 408, the device may determine an onboarding response received from the NFVO. For example, after the NFVO onboards the NSD, the NFVO may respond to the NM by sending an onboard NSD response to indicate the successful NSD onboarding.

It is understood that the above descriptions are for purposes of illustration and are not meant to be limiting.

FIG. 4B illustrates a flow diagram of an illustrative process 450 for a CU and DU connection in ac virtualized RAN system, in accordance with one or more example embodiments of the present disclosure.

At block 452, a device determine an onboarding request received from a network manager (NM), wherein the onboarding request comprises an indication to perform network service descriptor (NSD) onboarding, and wherein the onboarding request comprises latency attributes and bandwidth attributes. The device may be an NFVO. For example, an NM may request the NFVO to onboard the NSD including the virtual link descriptor and the virtual link profile that contain the latency and bandwidth attributes. The NFVO may receive the onboarding request from the NM. The virtual link descriptor, the virtual link profile, and a VirtualLinkToLevelMapping information element (for the virtual links (VLs)) in an NS level are needed for the creation of VLs to connect the virtualized part and the non-virtualized part of the gNB.

At block 454, the device may onboard a network service (NS) instance of the NSD based on the latency and bandwidth attributes included in the onboarding request.

At block 456, the device may cause to send an onboarding response to the NM, wherein the onboarding response indicates a result of success or failure of the onboarding of the NSD. After the NFVO onboards the NSD, the NFVO may respond to the NM by sending an onboard NSD response to indicate the successful NSD onboarding.

It is understood that the above descriptions are for purposes of illustration and are not meant to be limiting.

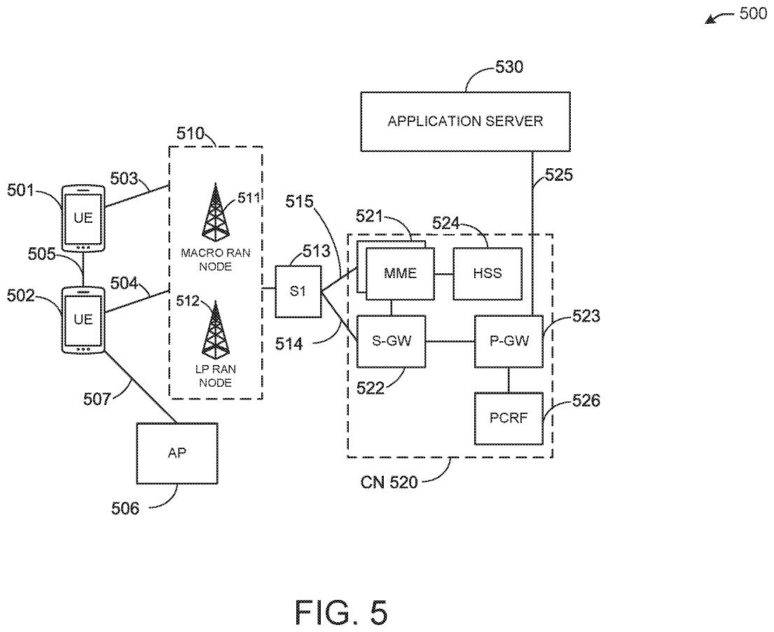

FIG. 5 illustrates an architecture of a system 500 of a network, in accordance with one or more example embodiments of the present disclosure.

The system 500 is shown to include a user equipment (UE) 501 and a UE 502. The UEs 501 and 502 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 501 and 502 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 501 and 502 may be configured to connect, e.g., communicatively couple, with a radio access network (RAN) 510—the RAN 510 may be, for example, an Evolved Universal Mobile Telecommunications System (UMTS) Terrestrial Radio Access Network (E-UTRAN), a NextGen RAN (NG RAN), or some other type of RAN. The UEs 501 and 502 utilize connections 503 and 504, respectively, each of which comprises a physical communications interface or layer (discussed in further detail below); in this example, the connections 503 and 504 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 501 and 502 may further directly exchange communication data via a ProSe interface 505. The ProSe interface 505 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 502 is shown to be configured to access an access point (AP) 506 via connection 507. The connection 507 can comprise a local wireless connection, such as a connection consistent with any IEEE 802.11 protocol, wherein the AP 506 would comprise a wireless fidelity (Wi-Fi®) router. In this example, the AP 506 is shown to be connected to the Internet without connecting to the core network of the wireless system (described in further detail below).

The RAN 510 can include one or more access nodes that enable the connections 503 and 504. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 510 may include one or more RAN nodes for providing macrocells, e.g., macro RAN node 511, and one or more RAN nodes for providing femtocells or picocells (e.g., cells having smaller coverage areas, smaller user capacity, or higher bandwidth compared to macrocells), e.g., low power (LP) RAN node 512.

Any of the RAN nodes 511 and 512 can terminate the air interface protocol and can be the first point of contact for the UEs 501 and 502. In some embodiments, any of the RAN nodes 511 and 512 can fulfill various logical functions for the RAN 510 including, but not limited to, radio network controller (RNC) functions such as radio bearer management, uplink and downlink dynamic radio resource management and data packet scheduling, and mobility management.

In accordance with some embodiments, the UEs 501 and 502 can be configured to communicate using Orthogonal Frequency-Division Multiplexing (OFDM) communication signals with each other or with any of the RAN nodes 511 and 512 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 511 and 512 to the UEs 501 and 502, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 501 and 502. The physical downlink control channel (PDCCH) may carry information about the transport format and resource allocations related to the PDSCH channel, among other things. It may also inform the UEs 501 and 502 about the transport format, resource allocation, and H-ARQ (Hybrid Automatic Repeat Request) information related to the uplink shared channel Typically, downlink scheduling (assigning control and shared channel resource blocks to the UE within a cell) may be performed at any of the RAN nodes 511 and 512 based on channel quality information fed back from any of the UEs 501 and 502. The downlink resource assignment information may be sent on the PDCCH used for (e.g., assigned to) each of the UEs 501 and 502.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 510 is shown to be communicatively coupled to a core network (CN) 520—via an S1 interface 513. In embodiments, the CN 520 may be an evolved packet core (EPC) network, a NextGen Packet Core (NPC) network, or some other type of CN. In this embodiment the S1 interface 513 is split into two parts: the S1-U interface 514, which carries traffic data between the RAN nodes 511 and 512 and the serving gateway (S-GW) 522, and the S1-mobility management entity (MME) interface 515, which is a signaling interface between the RAN nodes 511 and 512 and MMEs 521.

In this embodiment, the CN 520 comprises the MMEs 521, the S-GW 522, the Packet Data Network (PDN) Gateway (P-GW) 523, and a home subscriber server (HSS) 524. The MMEs 521 may be similar in function to the control plane of legacy Serving General Packet Radio Service (GPRS) Support Nodes (SGSN). The MMEs 521 may manage mobility aspects in access such as gateway selection and tracking area list management. The HSS 524 may comprise a database for network users, including subscription-related information to support the network entities' handling of communication sessions. The CN 520 may comprise one or several HSSs 524, depending on the number of mobile subscribers, on the capacity of the equipment, on the organization of the network, etc. For example, the HSS 524 can provide support for routing/roaming, authentication, authorization, naming/addressing resolution, location dependencies, etc.

The S-GW 522 may terminate the S1 interface 513 towards the RAN 510, and routes data packets between the RAN 510 and the CN 520. In addition, the S-GW 522 may be a local mobility anchor point for inter-RAN node handovers and also may provide an anchor for inter-3GPP mobility. Other responsibilities may include lawful intercept, charging, and some policy enforcement.

The P-GW 523 may terminate a SGi interface toward a PDN. The P-GW 523 may route data packets between the EPC network 523 and external networks such as a network including the application server 530 (alternatively referred to as application function (AF)) via an Internet Protocol (IP) interface 525. Generally, the application server 530 may be an element offering applications that use IP bearer resources with the core network (e.g., UMTS Packet Services (PS) domain, LTE PS data services, etc.). In this embodiment, the P-GW 523 is shown to be communicatively coupled to an application server 530 via an IP communications interface 525. The application server 530 can also be configured to support one or more communication services (e.g., Voice-over-Internet Protocol (VoIP) sessions, PTT sessions, group communication sessions, social networking services, etc.) for the UEs 501 and 502 via the CN 520.

The P-GW 523 may further be a node for policy enforcement and charging data collection. Policy and Charging Enforcement Function (PCRF) 526 is the policy and charging control element of the CN 520. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 526 may be communicatively coupled to the application server 530 via the P-GW 523. The application server 530 may signal the PCRF 526 to indicate a new service flow and select the appropriate Quality of Service (QoS) and charging parameters. The PCRF 526 may provision this rule into a Policy and Charging Enforcement Function (PCEF) (not shown) with the appropriate traffic flow template (TFT) and QoS class of identifier (QCI), which commences the QoS and charging as specified by the application server 530.

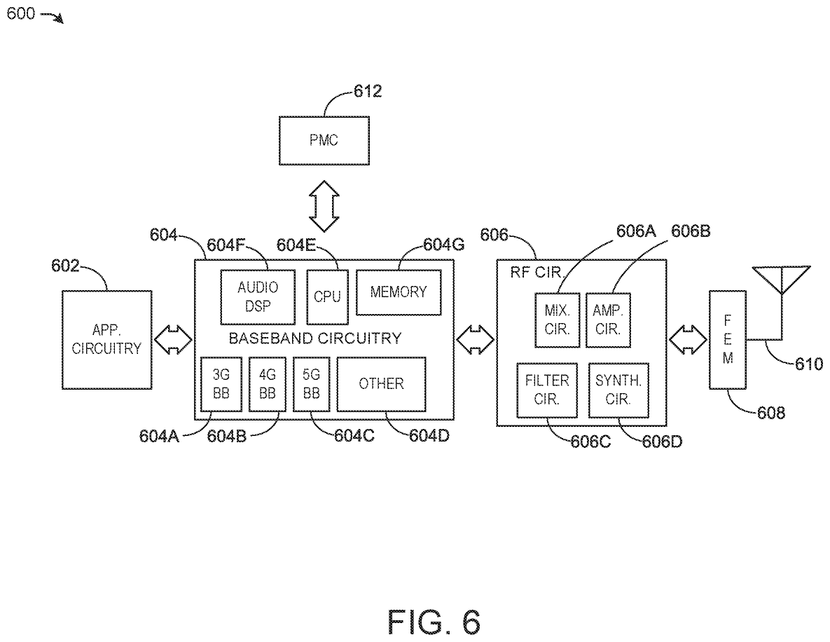

FIG. 6 illustrates example components of a device 600, in accordance with one or more example embodiments of the present disclosure.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE or a RAN node. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuitry 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), si6h generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a requirement. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a requirement. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604. However, in other embodiments, the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in an RRC_Connected state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 602 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

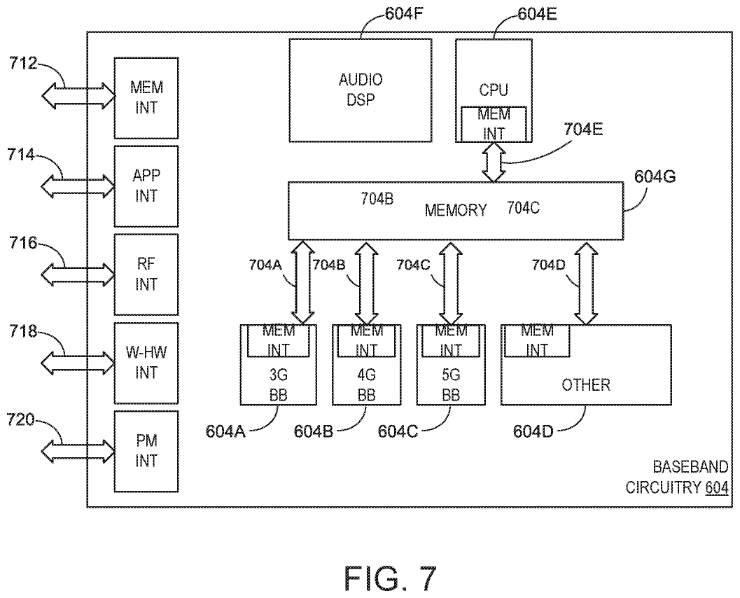

FIG. 7 illustrates example interfaces of baseband circuitry, in accordance with one or more example embodiments of the present disclosure.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory e6ernal to the baseband circuitry 604), an application circuitry interface 714 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

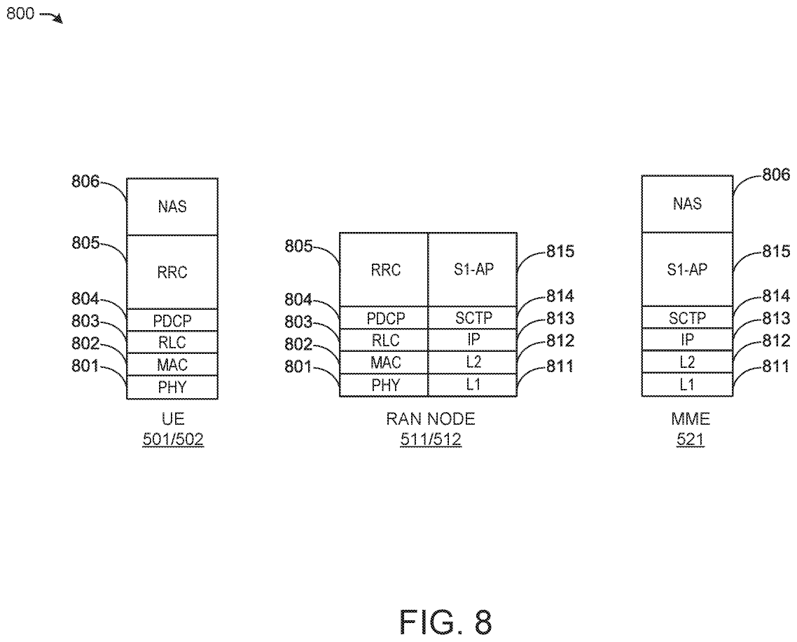

FIG. 8 is an illustration of a control plane protocol stack, in accordance with one or more example embodiments of the present disclosure.

In this embodiment, a control plane 800 is shown as a communications protocol stack between the UE 501 (or alternatively, the UE 502), the RAN node 511 (or alternatively, the RAN node 512), and the MME 521.

The PHY layer 801 may transmit or receive information used by the MAC layer 802 over one or more air interfaces. The PHY layer 801 may further perform link adaptation or adaptive modulation and coding (AMC), power control, cell search (e.g., for initial synchronization and handover purposes), and other measurements used by higher layers, such as the RRC layer 805. The PHY layer 801 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 802 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 803 may operate in a plurality of modes of operation, including Transparent Mode (TM), Unacknowledged Mode (UM), and Acknowledged Mode (AM). The RLC layer 803 may execute transfer of upper layer protocol data units (PDUs), error correction through automatic repeat request (ARQ) for AM data transfers, and concatenation, segmentation and reassembly of RLC SDUs for UM and AM data transfers. The RLC layer 803 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 804 may execute header compression and decompression of IP data 913, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 805 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 501 and the RAN node 511 may utilize a Uu interface (e.g., an LTE-Uu interface) to exchange control plane data via a protocol stack comprising the PHY layer 801, the MAC layer 802, the RLC layer 803, the PDCP layer 804, and the RRC layer 805.

The non-access stratum (NAS) protocols 806 form the highest stratum of the control plane between the UE 501 and the MME 521. The NAS protocols 806 support the mobility of the UE 501 and the session management procedures to establish and maintain IP connectivity between the UE 501 and the P-GW 523 of FIG. 5.

The S1 Application Protocol (S1-AP) layer 815 may support the functions of the S1 interface and comprise Elementary Procedures (EPs). An EP is a unit of interaction between the RAN node 511 and the CN 520. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 814 may ensure reliable delivery of signaling messages between the RAN node 511 and the MME 521 based, in part, on the IP protocol, supported by the IP layer 813. The L2 layer 812 and the L1 layer 811 may refer to communication links (e.g., wired or wireless) used by the RAN node and the MME to exchange information.

The RAN node 511 and the MME 521 may utilize an S1-MME interface to exchange control plane data via a protocol stack comprising the L1 layer 811, the L2 layer 812, the IP layer 813, the SCTP layer 814, and the S1-AP layer 815.

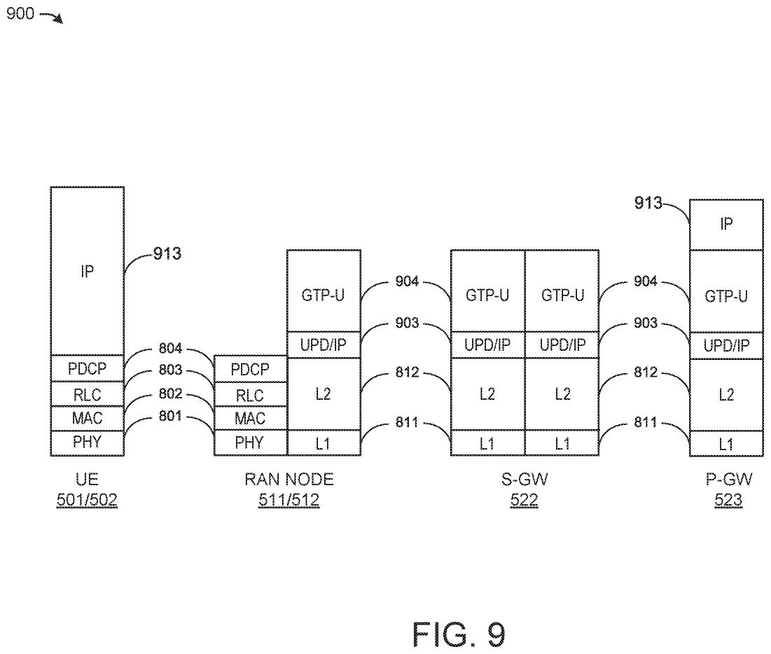

FIG. 9 is an illustration of a user plane protocol stack, in accordance with one or more example embodiments of the present disclosure.

In this embodiment, a user plane 900 is shown as a communications protocol stack between the UE 501 (or alternatively, the UE 502), the RAN node 511 (or alternatively, the RAN node 512), the S-GW 522, and the P-GW 523. The user plane 900 may utilize at least some of the same protocol layers as the control plane 800. For example, the UE 501 and the RAN node 511 may utilize a Uu interface (e.g., an LTE-Uu interface) to exchange user plane data via a protocol stack comprising the PHY layer 801, the MAC layer 802, the RLC layer 803, the PDCP layer 804.

The General Packet Radio Service (GPRS) Tunneling Protocol for the user plane (GTP-U) layer 904 may be used for carrying user data within the GPRS core network and between the radio access network and the core network. The user data transported can be packets in any of IPv4, IPv6, or PPP formats, for example. The UDP and IP security (UDP/IP) layer 903 may provide checksums for data integrity, port numbers for addressing different functions at the source and destination, and encryption and authentication on the selected data flows. The RAN node 511 and the S-GW 522 may utilize an S1-U interface to exchange user plane data via a protocol stack comprising the L1 layer 811, the L2 layer 812, the UDP/IP layer 903, and the GTP-U layer 904. The S-GW 522 and the P-GW 523 may utilize an S5/S8a interface to exchange user plane data via a protocol stack comprising the L1 layer 811, the L2 layer 812, the UDP/IP layer 903, and the GTP-U layer 904. As discussed above with respect to FIG. 8, NAS protocols support the mobility of the UE 501 and the session management procedures to establish and maintain IP connectivity between the UE 501 and the P-GW 523.

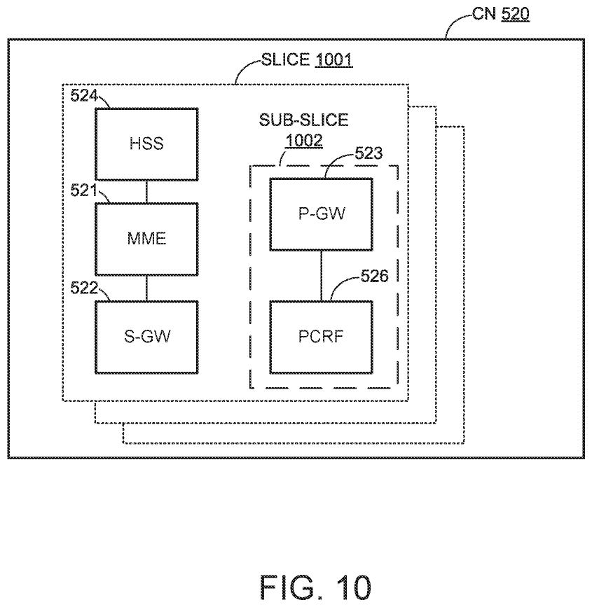

FIG. 10 illustrates components of a core network, in accordance with one or more example embodiments of the present disclosure.

The components of the CN 520 may be implemented in one physical node or separate physical nodes including components to read and execute instructions from a machine-readable or computer-readable medium (e.g., a non-transitory machine-readable storage medium). In some embodiments, Network Functions Virtualization (NFV) is utilized to virtualize any or all of the above described network node functions via executable instructions stored in one or more computer readable storage mediums (described in further detail below). A logical instantiation of the CN 520 may be referred to as a network slice 1001. The network slice 1001 may include an HSS 524, an MME 521, an S-GW 522, in addition to a network sub-slice 1002. A logical instantiation of a portion of the CN 520 may be referred to as a network sub-slice 1002 (e.g., the network sub-slice 1002 is shown to include the PGW 523 and the PCRF 526).

NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

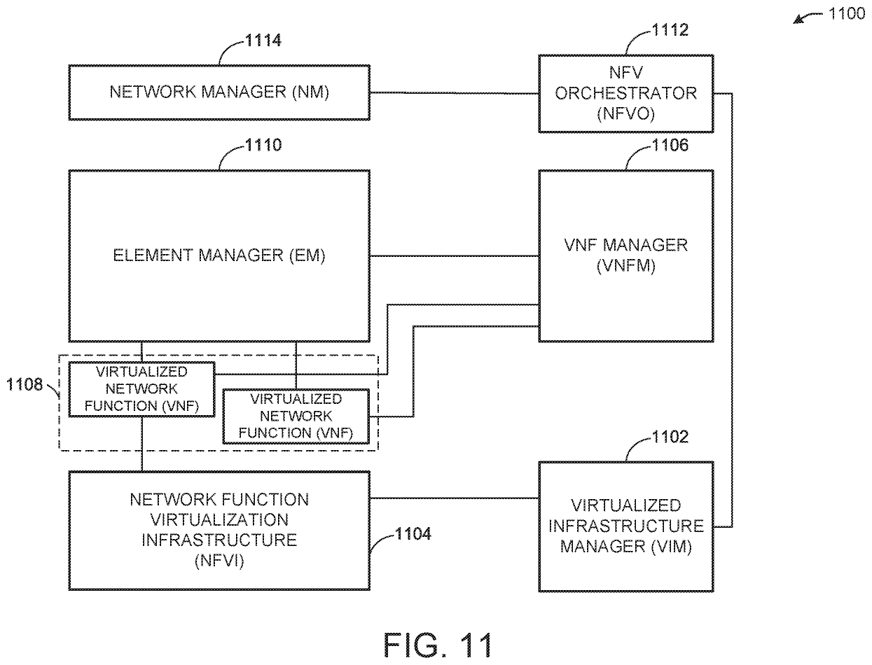

FIG. 11 is a block diagram illustrating components of a system 1100 to support NFV, in accordance with one or more example embodiments of the present disclosure.

The system 1100 is illustrated as including a virtualized infrastructure manager (VIM) 1102, a network function virtualization infrastructure (NFVI) 1104, a VNF manager (VNFM) 1106, virtualized network functions (VNFs) 1108, an element manager (EM) 1110, an NFV Orchestrator (NFVO) 1112, and a network manager (NM) 1114.

The VIM 1102 manages the resources of the NFVI 1104. The NFVI 1104 can include physical or virtual resources and applications (including hypervisors) used to execute the system 1100. The VIM 1102 may manage the life cycle of virtual resources with the NFVI 1104 (e.g., creation, maintenance, and tear down of virtual machines (VMs) associated with one or more physical resources), track VM instances, track performance, fault and security of VM instances and associated physical resources, and expose VM instances and associated physical resources to other management systems.

The VNFM 1106 may manage the VNFs 1108. The VNFs 1108 may be used to execute EPC components/functions. The VNFM 1106 may manage the life cycle of the VNFs 1108 and track performance, fault and security of the virtual aspects of VNFs 1108. The EM 1110 may track the performance, fault and security of the functional aspects of VNFs 1108. The tracking data from the VNFM 1106 and the EM 1110 may comprise, for example, performance measurement (PM) data used by the VIM 1102 or the NFVI 1104. Both the VNFM 1106 and the EM 1110 can scale up/down the quantity of VNFs of the system 1100.

The NFVO 1112 may coordinate, authorize, release and engage resources of the NFVI 1104 in order to provide the requested service (e.g., to execute an EPC function, component, or slice). The NM 1114 may provide a package of end-user functions with the responsibility for the management of a network, which may include network elements with VNFs, non-virtualized network functions, or both (management of the VNFs may occur via the EM 1110).

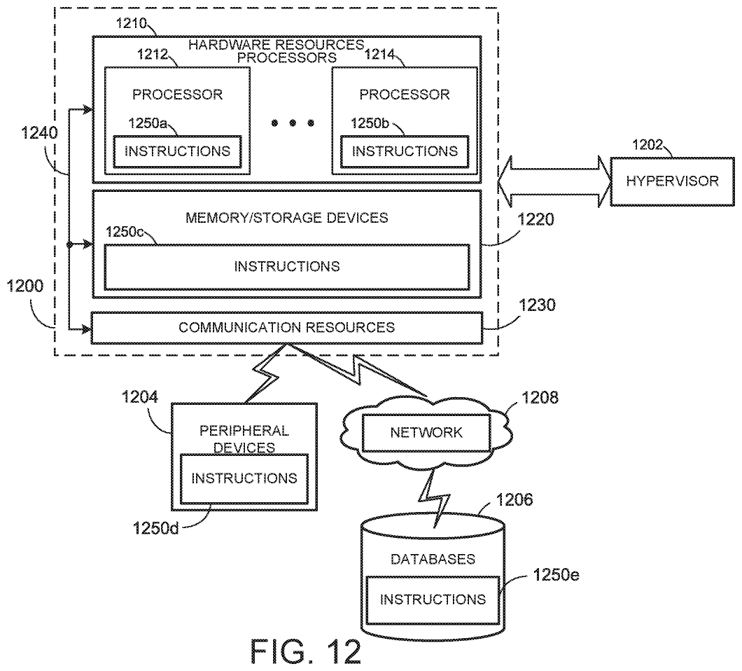

FIG. 12 is a block diagram illustrating one or more components, in accordance with one or more example embodiments of the present disclosure.

The one or more components able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1200 including one or more processors (or processor cores) 1210, one or more memory/storage devices 1220, and one or more communication resources 1230, each of which may be communicatively coupled via a bus 1240. For embodiments where node virtualization (e.g., NFV) is utilized, a hypervisor 1202 may be executed to provide an execution environment for one or more network slices/sub-slices to utilize the hardware resources 1200

The processors 1210 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1212 and a processor 1214.

The memory/storage devices 1220 may include main memory, disk storage, or any suitable combination thereof. The memory/storage devices 1220 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1230 may include interconnection or network interface components or other suitable devices to communicate with one or more peripheral devices 1204 or one or more databases 1206 via a network 1208. For example, the communication resources 1230 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1250 may comprise software, a program, an application, an applet, an app, or other executable code for causing at least any of the processors 1210 to perform any one or more of the methodologies discussed herein. The instructions 1250 may reside, completely or partially, within at least one of the processors 1210 (e.g., within the processor's cache memory), the memory/storage devices 1220, or any suitable combination thereof. Furthermore, any portion of the instructions 1250 may be transferred to the hardware resources 1200 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

In some embodiments, the electronic device(s), network(s), system(s), chip(s) or component(s), or portions or implementations thereof, of Figures herein may be configured to perform one or more processes, techniques, or methods as described herein, or portions thereof.

The following examples pertain to further embodiments.

Example 1 may include an apparatus, comprising: a New Radio (NR) RAN node or gNB that may include Centralized Unit (i.e., Upper Layer of New Radio BS) that may be implemented as Virtualized Network Functions (VNF) deployed in the cloud, and Distributed Unit (i.e., Lower Layer of New Radio BS) that may be implemented as Physical Network Functions (PNF) deployed in the cell site to provide wireless communication to UE.

Example 2 may include the subject matter of example 1 or some other example herein, wherein the interface between CU and DU should meet specific transport network requirements that are characterized by latency and bandwidth.

Example 3 may include the Network Manager (NM) comprising one or more processors is to: send a request to NFV Orchestrator (NFVO) to onboard the NS descriptor (NSD); and receive from NFVO the result of NSD onboard; and send a request to NFVO to update the NSD; and receive from NFVO the result of NSD update.

Example 4 may include the subject matter of example 3 or some other example herein, wherein the NM requests the NFVO to onboard the NSD with virtual link descriptor that contain the latency and bandwidth attributes needed for the creation of virtual links to connect CU and DU.

Example 5 may include the subject matter of example 3 or some other example herein, wherein the NM requests the NFVO to update the NSD by adding a VNFFGD, which include the virtual link descriptor that contain the latency and bandwidth attributes needed for the creation of virtual links to connect CU and DU.

Example 6 may include the subject matter of example 3 or some other example herein, wherein the NM requests the NFVO to update the virtual link descriptor containing latency and bandwidth attributes needed for the creation of virtual links to connect CU and DU.

Example 7 may include the NM of example 3 or some other example herein, wherein once a NSD is onboarded, NM comprising one or more processors is to: send a request to NFVO to create a new NS identifier; and receive from NFVO the new NS identifier; and send a request to NFVO to instantiate a NS that includes the instantiation of a new VNF to implement CU, and the deployment of a PNF to implement DU; and receive from NFVO the operation result containing the lifecycle operation occurrence identifier; and receive from NFVO the NS lifecycle change notification to NM indicating the start of NS instantiation; and send a request to NFVO to update a NS that includes the virtualized part and non-virtualized part of gNB; and receive from NFVO the operation result containing the lifecycle operation occurrence identifier; and receive from NFVO the NS lifecycle change notification to NM indicating the start of NS update; and receive from NFVO the NS Lifecycle Change notification to NM indicating the result of NS update.

Example 8 may include the subject matter of example 7 or some other example herein, wherein the NM requests the NFVO to use NS update to add a VNFFG to a NS with the VNFFG descriptor, which include the virtual link descriptor containing the latency and bandwidth attributes needed for the creation of virtual links to connect CU and DU.

Example 9 may include the NFVO of example 3 or some other example herein, wherein comprising one or more processors is to: perform NSD onboard in response to the NSD onboard request; and send the result of NSD onboard to NM; and perform NSD update in response to the NSD update request; and send the result of NSD update to NM.

Example 10 may include the NFVO of example 7 or some other example herein, wherein comprising one or more processors is to: send the NS identifier to NM; and send the operation result containing the lifecycle operation occurrence identifier to NM; and send the NS lifecycle change notification to NM indicating the start of NS instantiation to NM; and send the NS Lifecycle Change notification to NM indicating the result of NS instantiation to NM.

Example 11 may include a device comprising memory and processing circuitry configured to: determine a network service (NS) instance associated with a network service descriptor (NSD); determine latency attributes and bandwidth attributes associated with one or more virtual links associated with an interface between a first component of the device and a second component of the device; cause to send an onboarding request to a network function virtualization orchestrator (NFVO), wherein the onboarding request comprises the latency attributes and the bandwidth attributes; and determine an onboarding response received from the NFVO.

Example 12 may include the device of example 11 and/or some other example herein, wherein the first component may be a centralized unit (CU), and wherein the second component may be a distributed unit (DU).

Example 13 may include the device of example 11 and/or some other example herein, wherein the first component may be a virtualized network function (VNF) and the second component may be a physical network function (PNF).

Example 14 may include the device of example 11 and/or some other example herein, wherein the latency attributes and the bandwidth attributes are included in a virtual link descriptor.

Example 15 may include the device of example 11 and/or some other example herein, wherein the memory and the processing circuitry are further configured to connect the first component and the second component using the one or more virtual links.

Example 16 may include the device of example 11 and/or some other example herein, wherein the onboarding response may include an indicator of a success or a failure of the onboarding request.

Example 17 may include the device of example 11 and/or some other example herein, wherein the memory and the processing circuitry are further configured to: determine a virtualized network function forwarding graph descriptor (VNFFGD) may include a virtual link descriptor; and send an onboarding update request to update the NSD to add the VNFFGD.

Example 18 may include the device of example 17 and/or some other example herein, wherein the memory and the processing circuitry are further configured to send an onboarding update request to update the virtual link descriptor.

Example 19 may include the device of example 11 and/or some other example herein, wherein the memory and the processing circuitry are further configured to: determine a virtualized network function forwarding graph (VNFFG) including a virtual link descriptor; and cause to send an onboarding update request to add a virtualized network function forwarding graph (VNFFG) to the NS instance.

Example 20 may include the device of example 11 and/or some other example herein, wherein the memory and the processing circuitry are further configured to send a request to the NFVO to create an NS identifier.|

Example 21 may include a computer-readable medium storing computer-executable instructions which when executed by one or more processors result in performing operations comprising: determining an onboarding request received from a network manager (NM), wherein the onboarding request comprises an indication to perform network service descriptor (NSD) onboarding, and wherein the onboarding request comprises latency attributes and bandwidth attributes; onboard a NSD based on the latency attributes and the bandwidth attributes; and cause to send an onboarding response to the NM, wherein the onboarding response indicates a result of success or failure of the onboarding of the NSD.

Example 22 may include the computer-readable medium of example 21 and/or some other example herein, wherein the NSD may include information associated with characteristics of a Network Service (NS) that that can be used to instantiate a NS.

Example 23 may include the computer-readable medium of example 21 and/or some other example herein, wherein the latency attributes and bandwidth attributes are associated with one or more virtual links associated with an interface between a first component of and a second component.

Example 24 may include the computer-readable medium of example 21 and/or some other example herein, wherein the operations further comprise: receiving a request to perform an NSD update; performing the NSD update in response to the request; and causing to send a result of the NSD update to the NM.

Example 25 may include a method comprising: determining, by one or more processors of a device, a network service (NS) instance associated with a network service descriptor (NSD); determining latency attributes and bandwidth attributes associated with one or more virtual links associated with an interface between a first component of the device and a second component of the device; causing to send an onboarding request to a network function virtualization orchestrator (NFVO), wherein the onboarding request comprises the latency attributes and the bandwidth attributes; and determining an onboarding response received from the NFVO.

Example 26 may include the method of example 25 and/or some other example herein, wherein the first component may be a centralized unit (CU), and wherein the second component may be a distributed unit (DU).

Example 27 may include the method of example 25 and/or some other example herein, wherein the first component may be a virtualized network function (VNF) and the second component may be a physical network function (PNF).

Example 28 may include the method of example 25 and/or some other example herein, wherein the latency attributes and the bandwidth attributes are included in a virtual link descriptor.

Example 29 may include the method of example 25 and/or some other example herein, further comprising connecting the first component and the second component using the one or more virtual links.

Example 30 may include the method of example 25 and/or some other example herein, wherein the onboarding response may include an indicator of a success or a failure of the onboarding request.

Example 31 may include the method of example 25 and/or some other example herein, further comprising: determine a virtualized network function forwarding graph (VNFFG) including a virtual link descriptor; and causing to send an onboarding update request to add a virtualized network function forwarding graph (VNFFG) to the NS instance.

Example 32 may include the method of example 25 and/or some other example herein, further comprising: determining a virtualized network function forwarding graph descriptor (VNFFGD) may include a virtual link descriptor; and causing to send an onboarding update request to update the NSD to add the VNFFGD.

Example 33 may include the method of example 32 and/or some other example herein, further comprising sending an onboarding update request to update the virtual link descriptor.

Example 34 may include an apparatus comprising means to perform one or more elements of a method described in or related to any of examples 1-33, or any other method or process described herein.

Example 35 may include one or more computer-readable media comprising instructions to cause an electronic device, upon execution of the instructions by one or more processors of the electronic device, to perform one or more elements of a method described in or related to any of examples 1-33, or any other method or process described herein.

Example 36 may include an apparatus comprising logic, modules, or circuitry to perform one or more elements of a method described in or related to any of examples 1-33, or any other method or process described herein.

Example 37 may include a method, technique, or process as described in or related to any of examples 1-33, or portions or parts thereof.

Example 38 may include an apparatus comprising: one or more processors and one or more computer readable media comprising instructions that, when executed by the one or more processors, cause the one or more processors to perform the method, techniques, or process as described in or related to any of examples 1-33, or portions thereof.

Example 39 may include a signal as described in or related to any of examples 1-33, or portions or parts thereof.

Example 40 may include a signal in a wireless network as shown and described herein.

Example 41 may include a method of communicating in a wireless network as shown and described herein.

Example 42 may include a system for providing wireless communication as shown and described herein.

Example 43 may include a device for providing wireless communication as shown and described herein.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1.-20. (canceled)

21. A device, comprising logic, at least a portion of the logic is in hardware, the logic comprising computer-executable instructions to:
determine a network service (NS) instance associated with a network service descriptor (NSD);
determine latency attributes and bandwidth attributes associated with one or more virtual links associated with an interface between a first component of the device and a second component of the device;
cause to send an onboarding request to a network function virtualization orchestrator (NFVO), wherein the onboarding request comprises the latency attributes and the bandwidth attributes; and
determine an onboarding response received from the NFVO.

22. The device of claim 21, wherein the logic is further configured to execute the computer-executable instructions to connect the first component and the second component using the one or more virtual links.

23. The device of claim 21, wherein the onboarding response includes an indicator of a success or a failure of the onboarding request.

24. The device of claim 21, wherein the logic is further configured to execute the computer-executable instructions to:
determine a virtualized network function forwarding graph descriptor (VNFFGD) includes a virtual link descriptor; and
send an onboarding update request to update the NSD to add the VNFFGD.

25. The device of claim 24, wherein the logic is further configured to execute the computer-executable instructions to send an onboarding update request to update the virtual link descriptor.

26. The device of claim 21, wherein the logic is further configured to execute the computer-executable instructions to:
determine a virtualized network function forwarding graph (VNFFG) including a virtual link descriptor; and
cause to send an onboarding update request to add a virtualized network function forwarding graph (VNFFG) to the NS instance.

27. The device of claim 21, wherein the logic is further configured to execute the computer-executable instructions to send a request to the NFVO to create an NS identifier.|

28. A computer-readable medium storing computer-executable instructions which when executed by one or more processors result in performing operations comprising:
determining an onboarding request received from a network manager (NM), wherein the onboarding request comprises an indication to perform network service descriptor (NSD) onboarding, and wherein the onboarding request comprises latency attributes and bandwidth attributes;
onboard a NSD based on the latency attributes and the bandwidth attributes; and
cause to send an onboarding response to the NM, wherein the onboarding response indicates a result of success or failure of the onboarding of the NSD.

29. The computer-readable medium of claim 28, wherein the NSD includes information associated with characteristics of a Network Service (NS) that that can be used to instantiate a NS.

30. The computer-readable medium of claim 28, wherein the latency attributes and bandwidth attributes are associated with one or more virtual links associated with an interface between a first component of and a second component.

31. The computer-readable medium of claim 28, wherein the operations further comprise:
receiving a request to perform an NSD update;
performing the NSD update in response to the request; and
causing to send a result of the NSD update to the NM.

32. A method comprising:
determining, by one or more processors of a device, a network service (NS) instance associated with a network service descriptor (NSD);
determining latency attributes and bandwidth attributes associated with one or more virtual links associated with an interface between a first component of the device and a second component of the device;
causing to send an onboarding request to a network function virtualization orchestrator (NFVO), wherein the onboarding request comprises the latency attributes and the bandwidth attributes; and
determining an onboarding response received from the NFVO.

33. The method of claim 32, wherein the first component is a centralized unit (CU), and wherein the second component is a distributed unit (DU).

34. The method of claim 32, wherein the first component is a virtualized network function (VNF) and the second component is a physical network function (PNF).

35. The method of claim 32, wherein the latency attributes and the bandwidth attributes are included in a virtual link descriptor.

36. The method of claim 32, further comprising connecting the first component and the second component using the one or more virtual links.

37. The method of claim 32, wherein the onboarding response includes an indicator of a success or a failure of the onboarding request.

38. The method of claim 32, further comprising:
determine a virtualized network function forwarding graph (VNFFG) including a virtual link descriptor; and
causing to send an onboarding update request to add a virtualized network function forwarding graph (VNFFG) to the NS instance.

39. The method of claim 32, further comprising:
determining a virtualized network function forwarding graph descriptor (VNFFGD) includes a virtual link descriptor; and
causing to send an onboarding update request to update the NSD to add the VNFFGD.

40. The method of claim 39, further comprising sending an onboarding update request to update the virtual link descriptor.
